(19) United States
(12) Patent Application Publication
(10) Pub. No.: US 2017/0124896 A1
(43) Pub. Date: May 4, 2017

(54) SYSTEM AND METHOD FOR ENABLING A USER TO OVERCOME SENSITIVITY

(71) Applicant: DHARMA LIFE SCIENCES LLC, Sleepy Hollow, NY (US)

(72) Inventors: Jonnalagadda Sasidhar, Sleepy Hollow, NY (US); Shanthi Lakshmi Duraimani, Bangalore (IN); Sreenidhi Sundaran, Bangalore (IN)

(73) Assignee: DHARMA LIFE SCIENCES LLC, Sleepy Hollow, NY (US)

(21) Appl. No.: 14/985,478

(22) Filed: Dec. 31, 2015

Related U.S. Application Data
(63) Continuation-in-part of application No. 14/931,868, filed on Nov. 4, 2015.

(51) Int. Cl. G09B 9/00; A63F 13/25; G09B 5/02

(52) U.S. Cl. CPC G09B 9/00; G09B 5/02; A63F 13/25

(57) ABSTRACT

A system is provided for enabling a user to overcome sensitivity. The system is configured to enable the user to engage in a first and a second activity in a virtual environment, directed to rewire a first and a second defective wiring, respectively. The first defective wiring results in an individual amplifying one stimulus over other stimuli. The second defective wiring results in inability to consider and weigh all the stimuli which is required for them to give an appropriate response. Symptom of the first and the second defective wirings is sensitivity. Engagement in the second activity is enabled after the user has at least participated in the first activity. Automated instructions are provided to the user to engage in activities performed in a real world environment directed to rewire the first and the second defective wiring.

### CROSS REFERENCE TO RELATED APPLICATION

This application is a continuation-in-part application of U.S. patent application Ser. No. 14/931,868 filed Nov. 4, 2015 entitled SYSTEM AND METHOD FOR ENABLING A USER TO OVERCOME WEAK BEHAVIORAL TRAITS, which is hereby incorporated herein by reference. Benefits of priorities to all related applications are claimed.

### BACKGROUND

Unless otherwise indicated herein, the materials described in this section are not prior art to the claims in this application and are not admitted to be prior art by inclusion in this section.

The subject matter in general relates to behavioral traits in humans, and more particularly but not exclusively, the subject matter is directed to a technical solution to overcome sensitivity, which is a weak behavioral trait.

An individual's behavior towards others, attitudes and characteristics, defines his personality. Each individual's personality is a combination of both positive and negative traits. A person may be driven by his positive traits at times and by negative traits at other times. As a result, to classify a person into a single personality type is difficult, as there are several different behavioral traits a person can have. Behavioral traits may be influenced by genes and/or by the environment where he grew up or may have spent most of his time during the stage of brain development. As an example, sensitivity may be caused by genetic predisposition, for example, an individual can inherit sensitivity from his parents or anyone in the family. Environmental factors such as, tendency of an individual to model the behavior of a highly sensitive family member, negligence shown to an individual by their caregivers in early life, physical, mental and sexual abuse, chronic fear or extreme distress, may cause an individual to become sensitive.

Understanding what makes people who they are has been a challenge in the world of psychology. One of the approaches used for determining the personality of a person is by way of taking a psychology based personality test. In such a test, the person answers a set of questions, and based on the answers gets a report detailing the type of personality that person may have. On the other hand, behavior of a person may be observed to determine weak personality traits in him. Behavior of a sensitive person may include sensitivity to subtle stimuli, over aroused, emotional reactivity, among others. Further, effects of criticism are especially amplified in highly sensitive people.

Negative or weak traits in a person can lead to difficulty in achieving their life goals. Conventionally, people try to overcome their weaknesses when one understands one's weaknesses or weak traits. An individual may approach a counselor or a psychologist with a view that, the counselor or the psychologist may be able to help him address his negative or weak trait. The person may have to undergo several sessions with the counselor. Such sessions may deal with the negative trait via a broad based general (not focused at the root of the weak trait) approach, which may be effective in the short run. For example, if a person is trying to deal with stress, the person may be advised to engage in regular exercise, outdoor games, engage socially and so on, which may prove effective to an extent for the time being.

Currently, there are multiple games and applications that may work in the same way as a counseling process. Even these games deal with the negative trait via a general approach. As an example if a person is not capable of reading at good speed, the person is subjected to games related to reading to improve his speed of reading. Such approach may be effective in the short run and does not address negative traits in a wholesome manner.

In light of the foregoing discussion there is a need for an improved technique to overcome sensitivity, which can be classified as a weak personality trait based on the goals of the person.

### SUMMARY

An embodiment provides a system for enabling a user to overcome sensitivity. The system includes an activity module. The activity module is configured to enable the user to engage in at least a first activity in a virtual environment. The first activity is directed to rewire a first defective wiring of the brain. The first defective wiring results in an individual amplifying one stimulus over other stimuli. The activity module is further configured to enable the user to engage in at least a second activity in the virtual environment. The second activity is directed to rewire a second defective wiring of the brain. The second defective wiring results in inability to consider and weigh all the stimuli which is required for them to give an appropriate response. Symptom of the first and the second defective brain wirings is sensitivity. Additionally, the activity module is configured to provide automated instructions to the user to engage in at least one activity, wherein the one activity is performed in a real world environment. The activity is directed to rewire the first defective wiring of the brain. Furthermore, the activity module is configured to provide automated instructions to the user to engage in yet another activity. The yet another activity is performed in the real world environment. The yet another activity is directed to rewire the second defective wiring of the brain.

Another embodiment provides a method for enabling a user to overcome sensitivity. The method includes enabling the user to engage in at least a first activity in a virtual environment. The first activity is directed to rewire a first defective wiring of the brain. The first defective wiring results in an individual amplifying one stimulus over other stimuli. The user is enabled to engage in at least a second activity in the virtual environment. The second activity is directed to rewire a second defective wiring of the brain. The second defective wiring results in inability to consider and weigh all the stimuli which is required for them to give an appropriate response. Symptom of the first and the second defective wirings is sensitivity. Further, automated instructions are provided to the user to engage in at least one activity. The one activity is performed in a real world environment. The activity is directed to rewire the first defective wiring of the brain. Furthermore, automated instructions are provided to the user to engage in yet another activity. The yet another activity is performed in the real world environment. The yet another activity is directed to rewire the second defective wiring of the brain.

Yet another embodiment provides a system for enabling a user to overcome sensitivity. The system includes an activity module configured to enable the user to engage in at least a first activity in a virtual environment, wherein the first activity is directed to rewire a first defective wiring of the brain, wherein the first defective wiring results in an individual amplifying one stimulus over other stimuli. The activity module is further configured to enable the user to engage in at least a second activity in the virtual environment, wherein the second activity is directed to rewire a second defective wiring of the brain, wherein the second defective wiring results in inability to consider and weigh all the stimuli which is required for them to give an appropriate response, wherein symptom of the first and the second defective wirings is sensitivity, wherein engagement in the second activity is enabled after the user has at least participated in the first activity.

### BRIEF DESCRIPTION OF THE DRAWINGS

Embodiments are illustrated by way of example and not limitation in the Figures of the accompanying drawings, in which like references indicate similar elements and in which:

FIG. 1 is an exemplary architecture of an exemplary system 100 to overcome sensitivity;

FIG. 2 is a block diagram of an exemplary activity module 200 to overcome sensitivity;

FIG. 2A is a block diagram of an exemplary behavioral traits database 202 of the activity module 200 to overcome sensitivity;

FIG. 2B is a block diagram of an exemplary collection of games 204 present in the activity module 200 to overcome sensitivity;

FIG. 2C is a block diagram of an exemplary actions database 206 of the activity module 200 to overcome sensitivity; and

FIG. 3 illustrates a flowchart of an exemplary method for overcoming sensitivity.

### DETAILED DESCRIPTION

VI. OVERVIEW
VII. PRINCIPLE
VIII. SYSTEM ARCHITECTURE
IX. MODULES OF SYSTEM TO OVERCOME SENSITIVITY
X. METHOD FOR OVERCOMING SENSITIVITY

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### I. Overview

Embodiments provide a technical solution to overcome sensitivity, which is a weak behavioral trait. The solution is based on a principle that genetic and environmental factors (may be referred to as “cause”) cause defects in human brain wiring (may be referred to as “defect”), and such defects in human brain wiring express themselves in the form of sensitivity (may be referred to as “symptoms”); hence, to overcome sensitivity, the defective brain wirings have to be rewired, thereby providing a wholesome and long term solution to weak behavioral traits.

In an embodiment, a system is provided to overcome sensitivity. The system may include an activity module. The activity module may be configured to enable the user to engage in activities in a virtual environment. The activities in the virtual environment facilitate rewiring of defective brain wirings, wherein the symptom of the detective brain wirings is sensitivity. The activity module may be further configured to provide automated instructions to gradually expose the user to situations in a real environment. The situations may be generally uncomfortable to the user as a result of the defective brain wirings. Exposure to such situation facilitates rewiring of the defective brain wirings.

The activity in the virtual environment may be a brain game. There may be a plurality of levels in the brain game. Each level in the game may have to be successfully completed by the user to unlock a subsequent higher level in the game.

The real world activity may take place in the real world environment, subsequent to the brain games. There may be a plurality of levels in the real world activity.

### II. Principle

Sensitivity or insensitivity may be defined as the degree of awareness and responsiveness, in an individual, to internal and external changes, challenges or demands. High sensitivity is characterized by sensitivity to both internal and external stimuli, including social and emotional cues and more easily overwhelmed when in a highly stimulating environment. They have in-depth processing of negative experiences. This is the reason they take more time to make decisions.

Sensitivity is in fact a symptom or consequence of the way an individual's brain is wired. The way an individual's brain is wired is based on the joint influence of genetic and environmental factors. With regards to each kind of brain wiring, genetic and environmental factors may work together in different proportions.

With regards to sensitivity, the brain of a sensitive person is wired such that the person amplifies one stimulus over other stimuli, which is a defective brain wiring. Additionally, the brain of a sensitive person is wired such that the person is unable to consider and weigh all the stimuli which are required for him to give an appropriate response, which may be considered as another defective brain wiring. Such defective brain wiring may have been caused by one or more of genetic predisposition. For example, an individual can inherit sensitivity from his parents or anyone in the family. Environmental factors such as, tendency of an individual to model the behavior of a highly sensitive family member, negligence shown to an individual by their caregivers in early life, physical, mental and sexual abuse, chronic tear or extreme distress, may cause an individual to become sensitive.

Embodiments provide a solution to rewire the defective brain wirings (addressing the defect) rather than just addressing the behavioral trait (symptom) without addressing the core defect. The solution is directed towards rewiring the defective brain wirings such that the ability to disable/suppress the amplification of one stimulus over other stimuli is increased and ability to consider and weigh all the stimuli which is required for them to give appropriate response is increased.

It is important to identify the brain wiring that results in development of a trait. A wholesome approach to overcome or eradicate a negative or a weak behavioral trait in a person would be to implement ways to rectify defect in the brain wiring.

Brain wirings may be referred to as connections of neural pathways in the brain. These connections of the brain form beliefs, thought patterns and response patterns to external stimulation. Rewiring may be referred to as a process of creating new brain wiring and stimulating a person's existing brain wirings so that his beliefs, thought patterns and responses to external stimulation change for the better.

A sensitive person tends to amplify one stimulus over other stimuli and they are unable to consider and weigh all the stimuli which are required for them to give an appropriate response. Different brain regions and neural network of the individual are responsible for such defects. Sensory Stimuli (S), Visual Processing Area (VPA), Insular Cortex (IC), Amygdala (AMY), Behavioral Inhibition System (BIS), Dorsolateral Prefrontal Cortex (DLPFC) are the important regions. When an internal or external stimuli is observed by a sensitive person, the amygdala gets activated, simultaneously the visual processing areas (such as, lateral temporal, medial, and posterior parietal regions, right claustrum, and left occipito temporal regions, left middle temporal gyrus, and the right subgyral temporal lobes) and the insular cortex get activated, which makes the person to get into in-depth negative processing, thereby, activating the behavioral inhibition system. Since the insular cortex processes the stimuli negatively, the dorsolateral prefrontal cortex does not perform reasoning and rational thinking.

### III. System Architecture

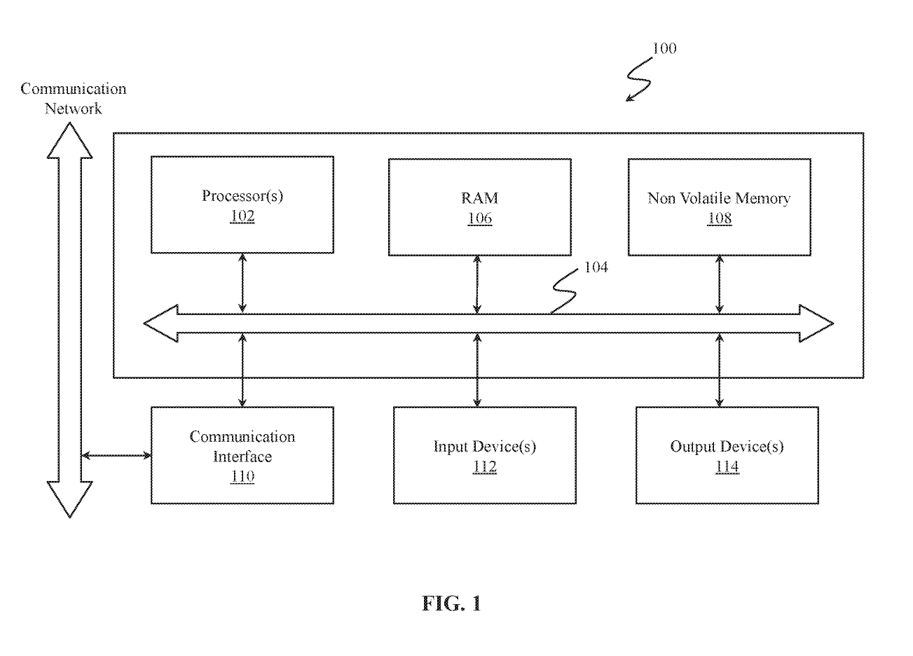

Referring to the figures, more particularly to FIG. 1, an exemplary architecture of an exemplary system 100 to overcome sensitivity is provided. The system 100 include one or more processors 102, a bus system 104, a random access memory 106, a disk drive or non-volatile memory 108, a communication interface 110, input device(s) 112 and output device(s) 114. Further, functionality of the system 100 may be distributed across multiple devices that may be located remotely from each other.

The processor 102 may be any hardware which returns output by accepting signals, such as electrical signals as input. In one embodiment, processors 102 may include one or more processing units (CPUs). The processor(s) 102 may communicate with a number of peripheral devices via the bus system 104. The processor(s) 102 may be implemented as appropriate in hardware, computer-executable instructions, firmware, or combinations thereof. Computer-executable instruction or firmware implementations of the processor(s) 102 may include computer-executable or machine-executable instructions written in any suitable programming language to perform the various functions described.

Communications interface 110 may provide an interface to other communication networks and devices. The input devices 112 may include all possible types of devices and mechanisms for inputting information to system 100. The output devices 114 may include all possible types of devices and mechanisms for outputting information from the system 100. The system 100 may include memory that may store data and program instructions that are loadable and executable on the processor(s) 102, as well as data generated during the execution of these programs. The memory may be volatile, such as random access memory 106 and/or a disk drive or non-volatile memory 108.

### IV. Modules of System to Overcome Sensitivity

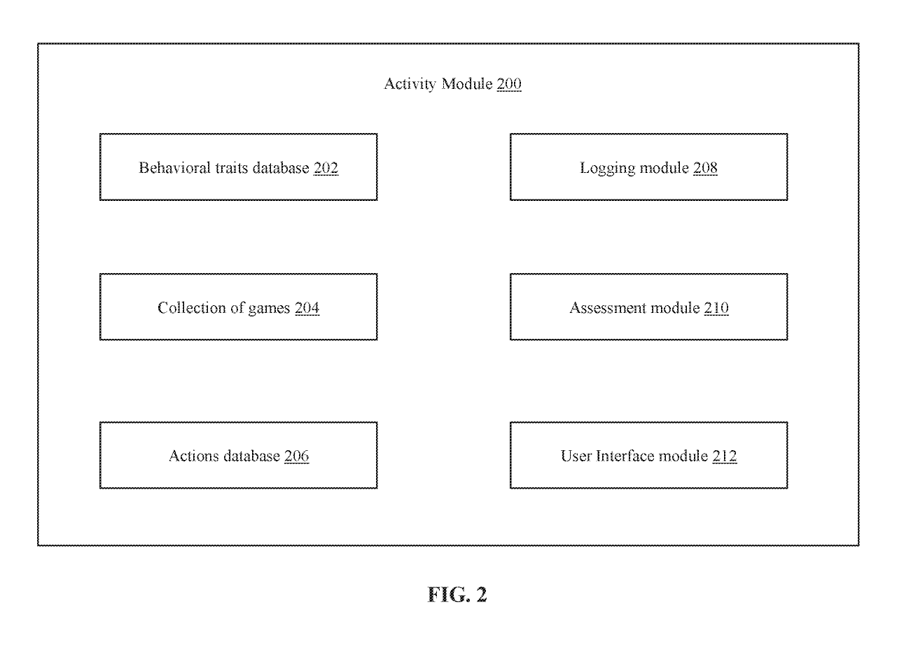

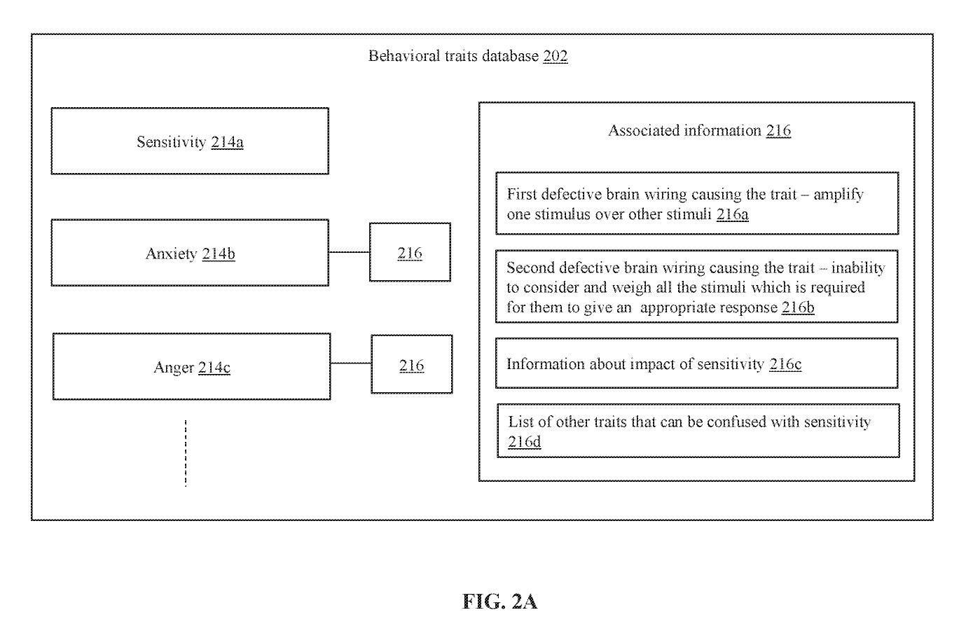

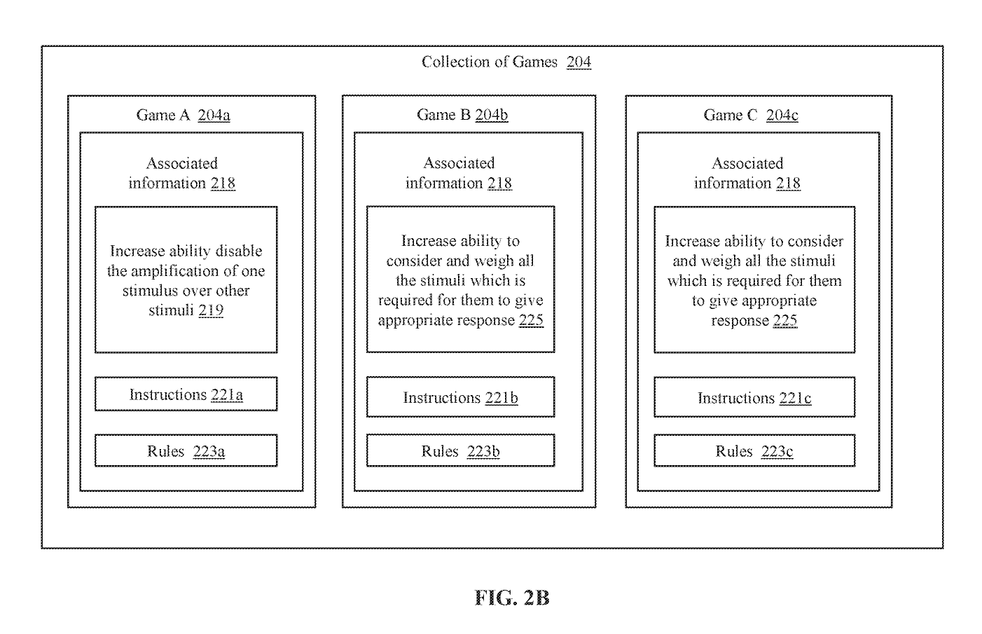

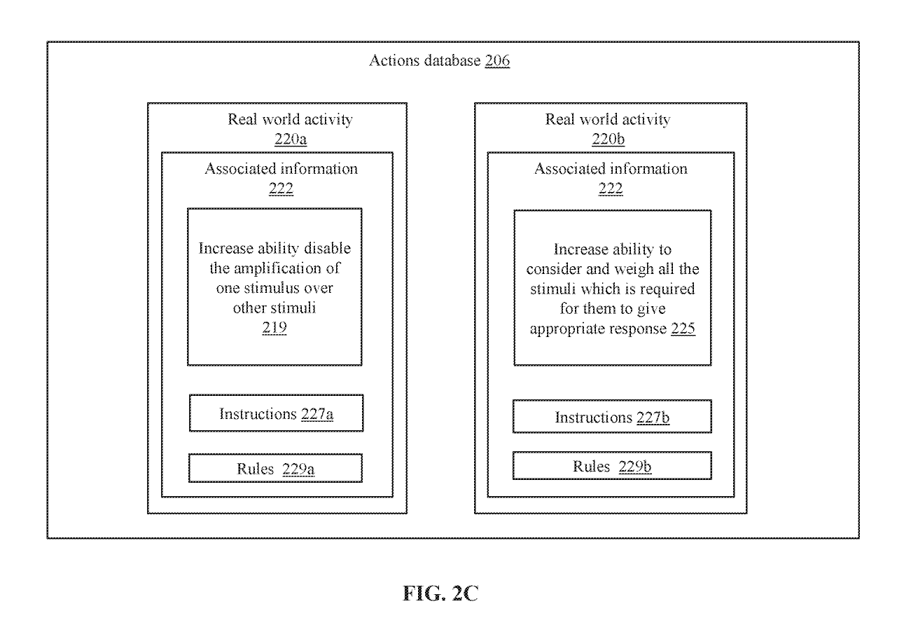

Referring to the figures, and more particularly to FIG. 2, the system 100 includes various modules for enabling users to overcome sensitivity. The system 100 includes an activity module 200. The activity module 200 may be a gaming module or an application module. The activity module 200 may be hosted by a communication device that enables a user to play games. Examples of such communication devices may include smart phone, tablet, notebook, laptop and desktop computer, among other devices.

The activity module 200 may include a behavioral traits database 202, a collection of games 204, an actions database 206, a logging module 208, an assessment module 210 and a user interface module 212.

### Behavioral Traits Database 202

Referring to FIG. 2A, in an embodiment, the behavioral traits database 202 may include a list of behavioral traits 214. Examples of behavioral traits 214 include, but not limited to, sensitivity 214a, anxiety 214b and anger 214c, among others. The traits database 202 may further include, with respect to one or more of the behavioral traits, information associated 216 with the trait 214.

With regards to sensitivity 214a, the associated information 216 may include information corresponding to the defective brain wirings (detects) 216a and 216b causing sensitivity (symptom of the defect), information about impact 216c of sensitivity 214a on a person, and a list 216d comprising one or more traits that may be confused with sensitivity 214a, among other information. Some or all of the associated information 216 may be displayed to the user of the activity module 200.

A first defective brain wiring 216a causing sensitivity 214a is the brain wiring causing an individual to amplify one stimulus over other stimuli. A second defective brain wiring 216b causing sensitivity 214a is the brain wiring causing inability to consider and weigh all the stimuli which are required for them to give an appropriate response.

In an embodiment, the information corresponding to the first and second defective brain wiring 216a and 216b causing the sensitivity 214a enables the activity module 200 to select games, activities or actions to overcome sensitivity 214a.

In an embodiment, displaying the information corresponding to the defective brain wiring (defect) 216a, 216b causing sensitivity 214a helps the user in understanding the defects responsible for sensitivity 214a, thereby motivating the user to follow the instructions provided by the activity module 200.

Information about impact 216c of sensitivity 214a can include one or more of sensitivity to subtle stimuli, over arousal, emotional reactivity and highly amplified effects of criticism, among others.

The list 216d of other traits that can be confused with sensitivity 214a include high empathy, low self esteem and anger, among others.

In an embodiment, the activity module 200 displays the information corresponding to the brain rewiring that the activity module 200 is attempting to achieve to overcome the weak behavioral trait 214, thereby enabling the user to understand the actual goal he will be instructed to work towards, which in turn can overcome sensitivity 214a.

With regards to sensitivity 214a, the brain rewiring attempted to achieve to overcome sensitivity 214a includes rewiring the defective brain wirings 216a, 216b such that ability to disable/suppress the amplification of one stimulus over other stimuli is increased and ability to consider and weigh all the stimuli which is required for them to give appropriate response.

In an embodiment, the activity module 200 may display the information corresponding to the causes (genetic or environmental) that resulted in the defective brain wirings (defect) 216a, 216b, which in turn resulted in sensitivity 214a, thereby enabling the user to relate to the cause, defect and symptom of the defect, which results in a wholesome experience while working to overcome sensitivity 214a.

### Collection of Games 204

The activity module 200 includes a collection of digital games 204, which are played in a virtual world. Each of the games 204 is used by the activity module 200 based on the brain rewiring, which the game 204 is capable of achieving.

Referring to FIG. 2B, in an embodiment, each game 204a-204d (may be referred to as game 204 or games 204) may include associated information 218. As an example, a game may be capable of achieving more than one type of brain rewiring. Alternatively, one single type of rewiring may be achieved through more than one game. Each game 204 includes data indicating the brain rewiring(s) 219, 225 it is capable of achieving, so that the activity module 200 can opt to present a choice of one or more games, which has the capability to achieve the brain rewiring, which the activity module 200 is attempting to achieve.

The associated information 218 may further include instructions 221 to be followed by the user to play the game 204. The associated information 218 may additionally include one or more rules 223. Examples of rules include rules for playing each game, rules to proceed to a higher level, scoring method in each level and time assigned to each level to reach the end of the level, among others.

In an embodiment, a higher level of the digital game 204 is unlocked based on predefined criteria.

In an embodiment, the higher level is unlocked upon repeatedly playing a previous level in the digital game 204 for a predefined number of times or duration of time.

In the example presented in FIG. 2B, different games 204a-204c are included in the collection of games 204. The games 204a-204c can be used by the activity module 200 to correct the defective brain wirings 216a and 216b by rewiring the brain to increase the ability to disable the amplification of one stimulus over other stimuli 219 and increase the ability to consider and weigh all the stimuli which is required for them to give appropriate response 225.

In an embodiment, one or more games among games 204a-204c may be played to overcome the defective brain wirings 219 and one or more games among games 204a-204c may be played to overcome the defective brain wirings 225.

In an embodiment, and as an example, Game A 204a may be directed at rewiring 219 the brain to increase the ability to disable the amplification of one stimulus over other stimuli. Games 204b-204c may be directed at rewiring 225 the brain to increase the ability to consider and weigh all the stimuli which is required for them to give appropriate response.

Game A 204a may be designed to rewire the brain to disable the amplification of one stimulus over other stimuli 219. In Game A 204a, a word depicting an emotional stimulus may be presented on one side of a see-saw. The user will be given options from which they should match the most appropriate word that equates to the emotional stimuli. When the right word is chosen, the see-saw will be balanced. There may be 3 kinds of stimuli, Positive, Negative, and Neutral stimuli, 70% of the time, the stimuli has to be neutral, 15% of the time, the stimuli can be positive stimuli and 15% of the time, the stimuli can be negative stimuli. Instructions 221a may include recommendation to play the game 204b for a minimum duration every day. The rules 223a may allow proceeding to a next level in the game 204a once a desired level of performance is achieved. Table 1 includes a list of stimuli (positive, negative and neutral) and the desired thought/response and the amplified thought/response, corresponding to every stimulus.

TABLE 1

| | | | |
|---|---|---|---|
| | | Neutral | Amplified |
| No | Stimuli | Thoughts | Thoughts |

Negative Stimuli

| | | | |
|---|---|---|---|
| 1 | Your friend is being | Funny | Rude |
| | Sarcastic | Witty | Impolite |
| | | Silly | Mean |
| | | Humorous | Offensive |
| | | Motivation | Idiotic |
| | | Egging on | Arrogant |
| | | Unintentional sarcasm | Dominating |
| | | Jovial | Aggressive |
| | | Pulling your leg | Annoying |
| | | | Criticizing |
| | | | Hatred |
| 2 | Your boss is | Leadership | Mean |
| | being Bossy | Smart | Dominating |
| | | Professional Role | Cunning |
| | | Strict | Unkind |
| | | Stern | Dictatorial |
| | | Obligation | Clever |
| | | It's just the situation | Arrogant |
| | | Deadlines | Impolite |
| | | Motivating | Over confident |
| | | Business minded | Proud |
| | | Management | Control freak |
| | | Multitasking | Dislike |
| | | Team success | Show off |
| 3 | Your partner is | Just being emotional | Dislikes |
| | shouting at you | It's just the situation | Hatred |
| | | Unintentional | Scary |
| | | Disturbed | Manipulative |
| | | Just had a bad day | Dominating |
| | | Other worries | Mean |
| | | Stressed | Rude |
| | | Temporary | Arrogant |
| | | | Abusive |
| | | | Crazy |
| | | | Hurting |
| | | | Taking advantage |
| | | | My fault |
| | | | Unloving |
| | | | Uncaring |
| 4 | Your boss is | Funny | Rude |
| | being sarcastic | Witty | Impolite |
| | | Silly | Mean |
| | | Humorous | Offensive |
| | | Motivation | Idiotic |
| | | Unintentional | Arrogant |
| | | Take it in my stride | Dominating |
| | | Does it to everyone | Snide |
| | | | Insulting |
| | | | Putting down |
| 5 | Criticism | Just an opinion | Mean |
| | | Constructive criticism | Rude |
| | | Feedback | Arrogant |
| | | Improvement | Judgmental |
| | | Well meaning | Hurtful talks |
| | | High expectations | Fault finding |
| | | | Holding grudge |
| | | | Hatred |
| | | | Putting down |
| 6 | Failed interview | High expectations | Hopeless |
| | | Can improve | Failure |
| | | Not meant to be | Never get a job |
| | | Other doors open | Not good enough |
| | | Nervousness | I'm incapable |
| | | Unsuitable | Unfortunate life |
| 7 | Rejection letter | High expectations | Hopeless |
| | | Can improve | Failure |
| | | Not meant to be | Unfortunate life |
| | | Other doors open | Not good enough |
| | | Nervousness | I'm incapable |
| | | Unsuitable | |

Neutral Stimuli

| | | | |
|---|---|---|---|
| 1 | Being Serious | Thinking | Angry |
| | | Day dreaming | Rude |
| | | Nostalgic | Strict |
| | | Preoccupied | Moody |
| | | Disturbed | Dreadful |
| | | Situation | Arrogant |
| | | Serious personality | Long faced |
| | | Sober | Holding grudge |
| | | Worries | Dislike |
| | | Shy | Unapproachable |
| | | | Scary |
| 2 | Negative tone of voice | Speaking out | Rude |
| | | Proving their point | Dominating |
| | | Lack of voice | Angry |
| | | modulation | Dreadful |
| | | Unintentional | Insensitive |
| | | Not in a good mood | Affected |
| | | Other issues | Hatred |
| | | Stressed | Mean |
| | | Anxious | No love |
| | | | Upset |
| | | | Hurtful |
| | | | Manipulative |
| | | | Dislike |
| 3 | Ignoring | Busy | Dislikes |
| | | Preoccupied | Hatred |
| | | Need space | I am annoying |
| | | Unintentional | I am |
| | | Situation | Bothersome |
| | | Stressed | Arrogant |
| | | | Angry |
| | | | Drifted apart |
| | | | Forgot me |
| | | | My fault |
| 10 | Constructive Criticism | Just an opinion | Mean |
| | | Greater good | Rude |
| | | Improvement | Arrogant |
| | | Feedback | Judgmental |
| | | Well meaning | Hurtful talks |
| | | High expectations | Fault finding |
| | | | Holding grudge |
| | | | Hatred |
| | | | Putting down |

Positive Stimuli

| | | | |
|---|---|---|---|
| 1 | You got an appraisal | Satisfied | I deserve |
| | | Self content | I am the best |
| | | Confident | I am a genius |
| | | Motivation | I am competent |
| | | No big deal | I am smart |
| | | Good luck | On top of the world |
| | | | Biggest achievement |
| 2 | You won a competition | Satisfied | I deserve |
| | | Self content | I am the best |
| | | Confident | I am competent |
| | | Motivation | I am smart |
| | | Good luck | I am blessed |
| | | No big deal | On top of the world |
| | | | Biggest achievement |
| 3 | You won a lottery | Satisfied | I deserve |
| | | No big deal | I am blessed |
| | | Temporary | Life is set |
| | | Probability | Rich |
| | | | Great future |

Game B 204b may be designed to rewire the brain to increase the ability to consider and weigh all the stimuli which is required for them to give appropriate response 225. The goal is to enable the user to weigh between the positive and/or negative history with that stimulus and then decide how they should respond. The instruction 221b may include recommendation to play the game 204b for a minimum duration every day. The rules 223b may allow proceeding to a next level in the game 204b once a desired level of performance is achieved.

In Game B 204b, a situation/event/scenario may be presented to the user. (A list of positive and negative events which occurred with respect to that stimulus may be provided) may be provided corresponding to the situation. The user will have to provide an appropriate answer or chose an answer based on the situation. An example is provided below.
Situation/event: Your spouse did not talk to you in the morning.
Stimuli (Negative)
1. He/she has stopped spending time with me since a few days.
2. We had a disagreement last night.
3. He/she has not been acknowledging my affections lately.
4. He/she had asked for more space in the relationship once.
5. He/she has not been expressing his/her interest in me for some time now.
6. We have been fighting a lot last week.
7. The qualities I liked in him/her changed over time in this relationship.
8. He/she keeps spending a lot of time with his/her friends.
9. His/her attention towards me has drastically reduced since a few days.
10. He/she does not deal with issues by talking about it.
Stimuli (Positive)
1. He/she had a bad day at work yesterday.
2. My spouse said that he/she did not sleep properly at night.
3. He/she had recently lost some money in the stock market.
4. When I had issues at work he/she has supported me.
5. It was only a few days back, that he/she gifted me.
6. He/she was complaining about a busy schedule at work.
7. Lately, there have been some issues and friction with his/her boss.
8. He/she did not speak much to anyone else in the family either.
9. There has been a change in behavior ever since he/she became responsible for the entire team.
10. From the past few days, my spouse has been sick.
Q. Is your relationship going haywire?
Answer: Yes or No

Game C 04c may be directed at rewiring 225, the second defective brain wiring 216b causing inability to consider and weigh all the stimuli which is required for them to give an appropriate response. The task in Game C 204c is to read a scenario and pick the options that best suit the user's response. The instruction 221d may include recommendation to play the game 204c for at least a predefined duration for a predefined number of days. The rules 223c may allow proceeding to a next level in the game 204c once a desired level of performance is achieved. An example is presented below.
Scenario:
In your company, you ask a favor to your colleague who is also your close friend. So there are some events happening in your personal front because of which you cannot spare sometime for the work that has been delegated to you. So you thought of asking your friend to finish it for you, but your friend tells that she cannot do it for you as he has his share of work that has to be completed. You feel very sad as she hasn't told no to any of your favors.
Q. So in such situation, what would you think?
A:
   She surely has started to dislike me.
   She knows my situations and still not ready to help me.
   Maybe she has other commitments because of which she is not able to consider my request.
   She has her own share of work, which has to be completed. She had mentioned that she has too much work stress.
Scenario: By the afternoon, your friend has not come to you to call you for lunch.
Q. So in this situation, what would you think?
A:
   Maybe we are not close as we were before. I should stop expecting anything from anyone. World is very unfair!
   Maybe she is stuck with work. I should go call her for lunch.
   She may be stuck with her work.
Scenario: Though she was late, she came and called you for lunch. She also mentions that why she couldn't consider your request. But while having lunch, you felt that your friend isn't talking to you much as she used to.
Q. So in this situation, what would you think?
A:
   I will just leave this place right now! As she is busy talking to her new friends.
   I′m just interpreting the situation wrongly.
   No, I′m just overreacting!
Scenario:
So in the evening, when leaving the office, your friend did not tell bye with smiling face.
Q. So in this situation, what would you think?
A:
   I should stop talking to her. I seriously expect a lot from people.
   May be she is too tired because of all the work pressure.
   May be she is too stressed. I should talk to her when I get back home.
Scenario:
Later the day, your friend gives you a call and tells you that she was very stressed with work and couldn't talk to you properly and asks if you could find someone to help you.
Q. So in this situation, what would you think?
A:
   My friend does care for me. She was just too stressed.
   I should have asked her if she needed some help than thinking just about me.
   She is feeling guilty and that is why she is calling now after doing all the things to hurt me.

### Actions Database 206

The actions database 206 includes information corresponding to a plurality of real world activities or sets of real world activities. Real world activities may include activities that are performed in a real world environment, as opposed to the digital games played in the virtual world (ex: games included in the collection of games 204).

Referring to FIG. 2C, each of the real world activities 220a-220b (may be referred by numeral 220) or sets of real world activities 220a-220b (may be referred by numeral 220) is used by the activity module 200 based on the brain rewiring 219, 225, which the real world activity 220 is capable of achieving.

Each real world activity 220a, 220b may include associated information 222. As an example, a real world activity may be capable of achieving more than one type of brain rewiring. Each real world activity 220a, 220b includes data indicating the brain rewiring(s) 219, 225 it is capable of achieving, so that the activity module 200 can opt to present a choice of one or more real world activities 220, which has the capability to achieve the brain rewiring, which the activity module 200 is attempting to achieve.

The associated information 222 may further include instructions 227 to be followed by the user to perform the real world activity 220 or a set of real world activities 220. The associated information 222 may additionally include one or more rules 229. Examples of rules include rules to proceed to a higher level, scoring method in each level and time assigned to each level to reach the end of the level, among others. Each level alternative should have an editable option where users can edit what is written and do what they think is feasible for that day, such that whatever they write, should be saved as that alternative and will show up 5 times.

The real world activity 220a may be presented to the user after the user has at least participated in at least one game 204a to a predefined extent that attempts to rewire 219 the first defective brain wiring 216a. The real world activity 220a may be designed to rewire the brain to disable the amplification of one stimulus over other stimuli. Instructions 227a may include recommendation that the action has to be carried out every day. For example, rules 229a may include recommendations that each level has to be repeated 5 times, before the next level unlocks.

In a first level, instructions 227a may be provided to the user to choose a quiet place to sit in and close the eyes and imagine in detail what is shown on a screen. The activity module 200 may choose the tasks to be shown on the screen sequentially and display it to the user.

### Screen 1:

Imagine a situation where you usually become very emotional. Imagine that situation in detail, with the people you would like to involve, the place where it is taking place. Think of how appropriately you can handle the situation and become an emotionally stable person in that situation.

### Example:

Situation: When someone who is close to you got angry
Imagination: You try to understand what they are telling and you refrain from getting angry/cry/brood over it. Your relationship with that person would not be affected because of this one situation.
Think of one of your friends who is emotionally stable, imagine yourself in that friend' position and how you would act in a stressful situation by being stable.
Think of a recent event where you had become very emotional. Imagine that situation with all the details, imagine how you would be able to think about how you have handled the situation differently without being emotional.

Example:
Situation: When you received a gift. You were extremely excited about it and your friends were surprised by your reaction.
Imagination: You be very happy about it and not get carried away by being too hyper emotional about it. You take the situation by balancing your emotions.
Think of the situation where someone is criticizing you, instead of the getting emotional, imagine yourself consciously trying to see what are reasons for the person to have triggered that reaction. Come up with the triggers of the person to criticizing you. By doing this, will be helping you to be more stable emotionally.
Think of a person who you are very close to. Imagine a situation where the person is ignoring you. Think of the possibilities why the person is avoiding you. Come up with at least 3 possibilities which is more balanced and not emotional.

### Screen 2:

On a scale of 1-10 how much would you rate your emotionality. Write how you felt after this imagery. A box may be provided for the user to key in his response.

In a second level, the activity module 200 may choose the tasks to be shown on the screen sequentially and display it to the user.

### Screen 1:

Try to identify the times you are usually emotional. Try to consciously be aware of your emotions.
When someone gets annoyed by you, think of the times they have been kind to you. The times they have made you laugh, made you feel special.
When you feel highly aroused, just move out of that situation. Seek out a empty spot where you can be yourself and reflect on yourself.
When there is a situation where you get emotional because of someone significant, try to consider their situation, rather than focusing only on your emotions.
When there is a situation where you are emotional, instead of thinking of the negatives, try to focus on the positives that is present in that situation

In a third level, the activity module 200 may choose the task to be shown on the screen and display it to the user.

### Screen 1:

Whenever there is a situation where someone was upset with you, think of the environmental cues/circumstances that could have triggered their reaction.

In a fourth level, the activity module 200 may choose the tasks to be shown on the screen sequentially and display it to the user.

### Screen 1:

Meet a person whose talks and remarks you think are insensitive. Try to remain unperturbed and neutral about their talks.

The real world activity 220b may be presented to the user after the user has at least participated in one or more games (204b and 204c) to a predefined extent that attempts to rewire 225 the second defective brain wiring 216b. The real world activity 220b may be designed rewire the brain to increase the ability to consider and weigh all the stimuli which is required for them to give appropriate response 225. Instructions 227b may include recommendation that the action has to be repeated once in a week and rules 229b may state that each level has to be repeated for a predefined number of times, before the next level unlocks. Real world activity 220b may include a plurality of levels.

In a first level, instructions 227b may be provided to the user to choose a quiet place to sit in and close the eyes and imagine in detail what is shown on a screen. The activity module 200 may choose the tasks to be shown on the screen and display it to the user sequentially.

### Screen 1:

Think of a situation where you might get emotional which could be for a negative situation (someone distressing you) or positive situation (receiving an appraisal). Imagine that you are being very balanced and not allow your emotional side dominates you. Evaluate the reasons and what could have been the circumstances. By keeping this in mind, try to weigh between the reasons and circumstances to provide an appropriate and balanced response.
Example:
Situation: You feel that someone is being sarcastic.
Imagination: The person is a jovial person, who is also friendly person. He may have not intended to be sarcastic and he is not a person who has the intention to hurt anyone. So you should not get angry about it.
Example:
Situation: You win a game. Your reaction surprised your friends and family members.
Imagination: You have played the game which you are very passionate about, so you do not have to be hyper emotional about the win. You just acknowledge the win and remain unperturbed.

In a second level:

### Screen 1:

When you feel that your friend/family member/colleague has made you feel like they are disappointed with you, think of reason why the person was upset with you.
Example:
Situation: Your mother snapped at you.
Imagination: You might have not been doing what your mother has been telling you to do; she might have had a had day. She is not a person who has the intention to hurt you.

### Screen 2:

Write down the reasons why the person was upset with you by the end of the day and reflect on them. They might have been in circumstances because of which their reaction was triggered. A box may be provided for the user to type his response.

In a third level:

### Screen 1

When someone is upset/criticizes/disappointed in you. Go back to them once you're calm and ask them why they were upset/criticizes/disappointed with you. After collecting those facts, rationalize before reaching a conclusion.
Example:
Situation: Your boss is disappointed in you.
Imagination: Your project was not up to the expectation, you were not giving your hundred percentage. You submitted the project with two days delay. So the boss was right in his way to be disappointed in you.

### Screen 2:

On a scale of 1-10 how much would you rate your emotionality. Write the rational conclusion you made. A box may be provided for the user to type his response.

In a fourth level:

### Screen 1:

Mentor another individual who is sensitive and who wants to change) and guide them on the skills that you have learned. This person could be your friend/family member or colleague.

In an embodiment, the action database 206 further includes plurality of physical actions, mind actions and dietary actions, one or more of which may be presented to a user who is trying to overcome sensitivity 214a.

Example of physical actions includes one or more physical activities, such as exercises and physical postures, among others. Example of mind actions may include meditation. Example of dietary actions may include adding specific food to one's diet or deleting specific food from the diet. As a further example, drinking black tea may be a dietary action and cutting down on rice consumption may be another dietary action.

### Logging Module 208

In an embodiment, the logging module 208 enables logging of the activities (ex: games, real world activities and other actions) performed by the user. The logging module 208 may record information corresponding to the activities performed by the user. The information may include one or more of, time of performance, date of performance, quantum of performance, success or failure consequent to an attempt to perform, and extent of success in performing the action, among others. The user may provide input that an activity has been performed. Such input may be used to log the activity in the logging module 208. Alternatively, the logging module 208 may be configured to automatically log the performance of an activity upon detection that the activity has been performed.

### Assessment Module 210

The assessment module 210 of the activity module 200 is configured to determine the performance of a user in each activity the user performs. The assessment module 210 may determine the user's score for each game and at each level in a game based on the log available in the logging module 208. Further, the assessment module 210 analyzes performance of the user in the real world activities and determines scores of each level of real world activity based on the log that is present in the logging module 208. The assessment module 210 may also determine status of the one or more behavioral trait 214 or the brain wiring causing the trait, after engaging in the activities, based on performance of activities suggested by the activity module 200.

### User Interface Module 2

The user interface module 212 may be configured to receive input from the user and display content to the user. The content displayed, can be, as an example, games, images, instructions, rules, information, haptic feedback and sound, among others.

### V. Method for Overcoming Sensitivity

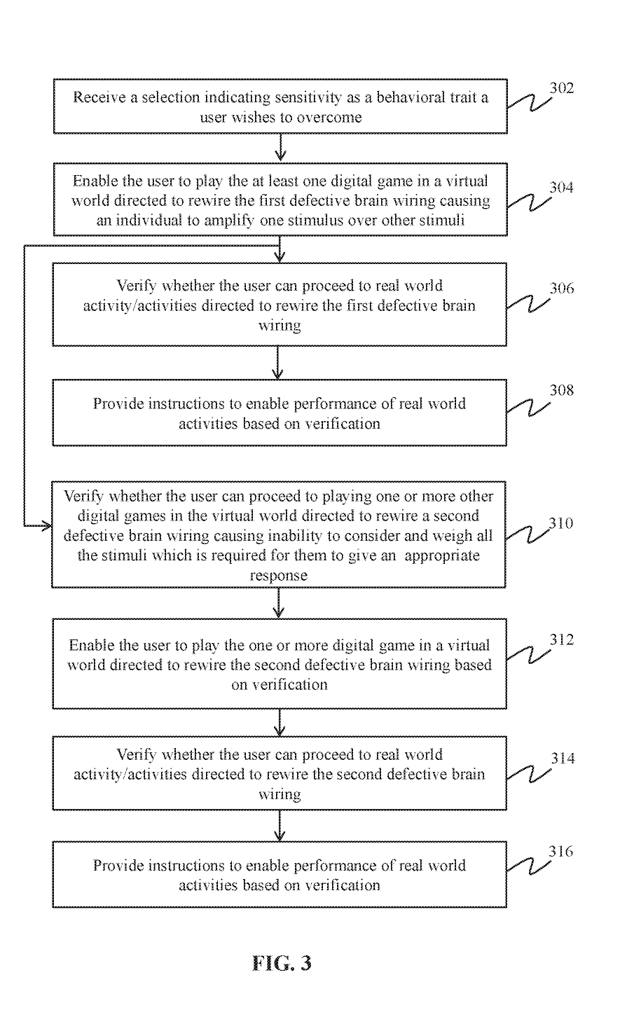

Now referring more particularly to FIG. 3, a method is provided for overcoming sensitivity 214a. A selection indicating sensitivity 214a as a behavioral trait which a user wishes to overcome is received at step 302. At step 304, a user is enabled to play/participate in at least one digital game 204a, which is played in a virtual world. The digital game 204a may be instrumental in rewiring 219 the first defective brain wiring 216a, whose symptom is exhibition of sensitivity 214a. At step 306, verification is made to determine whether the user can perform real world activities 220a. In case it is determined that user can proceed, then at step 308, instructions are provided to the user to enable the user to perform appropriate real world activity/activities 220a. Preferably, the user is allowed to perform or instructed to begin performing appropriate real world activities 220a upon participating in the digital game 204b at least to a predefined extent, which is determined based on the desired rewiring. The real world activity 220a is instrumental in rewiring 219 the first defective brain wiring 216a, whose symptom is exhibition of sensitivity 214a.

At step 310, verification is made to determine whether the user can proceed to playing one or more other digital games 204b and/or 204c in the virtual world directed to rewire a second defective brain wiring 216b. In case it is determined that user can proceed, then at step 312 the user is enabled to participate/play in the one or more digital games 204b and/or 204c, which is played in a virtual world. The digital games 204b and 204c are instrumental in rewiring 225 the second defective brain wiring 216b, whose symptom is exhibition of sensitivity 214a, Preferably, the user is allowed to proceed to playing at least one or all of the digital games 204b and 204c upon participating in the game(s) instrumental in rewiring 219 the first defective wiring 216a at least to a predefined extent, which is determined based on the desired rewiring.

At step 314, verification is made to determine whether the user can proceed to perform real world activities 220b. In case it is determined that user can proceed, then at step 316, instructions are provided to the user to enable the user to perform appropriate real world activity/activities 220b. Preferably, the user is allowed to perform or instructed to begin performing appropriate real world activities 220b upon participating in at least one or all of the digital game(s) 204b and 204c at least to a predefined extent, which is determined based on the desired rewiring. The real world activity 220b are instrumental in rewiring 225 the second defective brain wiring 216b, whose symptom is exhibition of sensitivity 214a.

Referring to the step (302) of receiving a selection indicating sensitivity 214a, the user may be provided an option to select a behavioral trait that he would like to overcome. The activity module 200 may provide or recommend an option to select at least one weak behavioral trait to work on. The user may select at least one behavioral trait 214 that the user thinks he needs to work on, from a list of behavioral traits that may be displayed to the user via the user interface module 212. Alternatively, the user may input answers in response to a set of questions displayed to the user, which may determine what type of weak behavioral trait 214 the user may have. Upon selection of sensitivity 214a, the activity module 200 may display a list 216d of other behavioral traits that can be confused with sensitivity 2 14a, so that the user can select a more appropriate behavioral trait 214, which he desires to work on. The activity module 200 may further display the information corresponding to the brain wirings (defect) 216a, 216b causing the behavioral trait 214. The first defective brain wiring 216a causes the individual to amplify one stimulus over other stimuli. The second defective brain wiring 216b causes inability to consider and weigh all the stimuli which is required for them to give an appropriate response.

The activity module 200 may additionally display information about impact 216c of sensitivity 214a to the user. In addition, the activity module 200 may display information corresponding to the brain rewiring 219 and 225 that the activity module 200 is attempting to achieve to overcome sensitivity 214a. Rewiring 219 of the first defective brain wiring 216a results in increased ability to disable the amplification of one stimulus over other stimuli. Rewiring 225 of the second defective brain wiring 216b results in increased ability to consider and weigh all the stimuli which is required for them to give appropriate response.

Furthermore, the activity module 200 may display the information corresponding to the causes (genetic or environmental) that resulted in the defective brain wirings (defect) 216a, 216b.

Referring to the step (304) of enabling the user to play one or more digital games in the virtual world directed to rewire the first and the second defective wiring 216a, 216b, the activity module 200 may select one or more digital games based on the capability of the digital games to achieve the desired brain rewiring 219, 225.

The activity module 200 may provide a choice (one or more games) of games, from which the user may select. The activity module 200 may even indicate the effectiveness of each of the games in achieving the desired brain rewiring or an aspect of rewiring.

In an embodiment, the activity module 200 is configured to recommend a plurality of games 204, wherein the recommendation indicates each of the games' 204 effectiveness to achieve the desired brain rewiring or an aspect of rewiring.

The activity module 200 allows the user to play the selected game. The logging module 208 may log the performance of the user. The assessment module 210 may determine the performance scores using the log in the logging module 208. Further, based on the respective rules 223, the user is either allowed or denied access to other levels of the game 204.

Referring to step 306, the activity module 200 verifies whether the user can proceed to perform real world activities 220. Preferably, the activity module 200 recommends real world activities 220 after the user has performed to a desired extent in the digital game(s) 204. Desired extent of performance can be, as an example, levels completed, score reached and duration over which the game 204 was played.

In an embodiment, the activity module 200 recommends participating in real world activity 220a or a part thereof, after the user has performed to a desired extent in the digital game 204a. Desired extent of performance can be, as an example, levels completed, score reached and duration over which the game(s) were played.

In an embodiment, the activity module 200 recommends participating in a level or part of real world activity (ex: level of real world activity 220a) after the user has performed to a desired extent in a level of the digital games (ex: level of digital game 204a), wherein the level of the digital game prepares the user to participate in the level or part of the real world activity,

In an embodiment, the activity module 200 is configured to recommend a plurality of real world activities or sets of real world activities 220, wherein the recommendation indicates each of the real world activities' or sets of real world activities' 220 effectiveness to achieve the desired brain rewiring.

The logging module 208 may log the performance of the user. The assessment module 210 may determine the performance scores using the log in the logging module 208. Further, based on the rules 229, the user is either allowed or denied access to other levels of the real world activities or sets of real world activities.

Referring to step 310, the activity module 200 verifies whether the user can proceed to playing one or more other digital games 204b and/or 204c in the virtual world directed to rewire the second defective brain wiring 216b causing inability to consider and weigh all the stimuli which is required for them to give an appropriate response. Rewiring the second defective brain wiring 216b results in ability to weigh between the errors in the task and the completion of the task.

In an embodiment, the activity module 200 recommends participating in digital games directed to rewire the second defective brain wiring 216b after the user has performed to a desired extent in the digital game(s) directed to rewire the first defective brain wiring 216a.

In an embodiment, the activity module 200 recommends participating in digital games directed to rewire the second defective brain wiring 216b after the user has performed to a desired extent in the digital game(s) and real world activity/activities directed to rewire the first defective brain wiring 216a.

The activity module 200, based on the verification, enables the user to play/participate in one or more other digital games 204c and 204d in the virtual world directed to rewire the second defective brain wiring 216b.

In an embodiment, the activity module 200 recommends participating in real world activity 220b or part thereof after the user has performed to a desired extent in the digital game 204b. Likewise, the activity module 200 recommends participating in real world activity 220b or part thereof after the user has performed to a desired extent in the digital game 204c. In another embodiment, the activity module 200 recommends participating in digital game 204c after the user has performed to a desired extent in a level of the digital game 204b.

Additionally, the activity module 200 may provide instruction to perform mind actions, physical actions and dietary actions.

Each of the physical and dietary actions may have effect on one or more hormones corresponding to one or more traits, among others. While executing the physical action the energy expended in the body is more compared to the energy expended while playing brain game. Similarly, the mind action may involve thinking about the specific trait in a way which may change the structure of the brain by changing the Axons, Receptors and/or the number of Neurons. The dietary action may include consuming specific foods which changes one or more hormone levels.

The real world, mind, physical and dietary activities are carried out in a real environment. Automated instructions are provided as to when and how the activities may have to be carried out. Further, there may be instructions that one or more of the real world activities may have to be carried out simultaneously with the brain games and one or more of the activities may have to be carried out prior to or after engaging in brain game (digital games) and performing to a desired extent.

In an embodiment, upon selecting sensitivity, the activity module 200 provides a scale operable by the user to select a position on the scale. The position may be indicative of the user's perception of his sensitivity. Improvement in sensitivity resulting from the rewiring of the brain achieved by the performance of the activities (virtual games or real world activities) enabled by the activity module 200 is reflected on the scale. Degradation of the improvement in sensitivity resulting from the degradation of the rewiring of the brain due to premature halt in performance of the activities (virtual games or real world activities) enabled by the activity module 200 is also reflected on the scale.

The games and the real world activities change the neural connections in the brain. When these activities are carried out repeatedly, new neural connections are formed (brain plasticity) but if one stops carrying out these activities prematurely then slowly the neural connections die.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for enabling a user to overcome sensitivity, the system comprising an activity module configured to:
enable the user to engage in at least a first activity in a virtual environment, wherein the first activity is directed to rewire a first defective wiring of the brain, wherein the first defective wiring results in amplifying one stimulus over other stimuli;
enable the user to engage in at least a second activity in the virtual environment, wherein the second activity is directed to rewire a second defective wiring of the brain, wherein the second defective wiring results in inability to consider and weigh all the stimuli which is required for them to give an appropriate response, wherein symptom of the first and the second defective wirings is sensitivity;
provide automated instructions to the user to engage in at least one activity, wherein the one activity is performed in a real world environment, wherein the activity is directed to rewire the first defective wiring of the brain; and
provide automated instructions to the user to engage in yet another activity, wherein the yet another activity is performed in the real world environment, wherein the yet another activity is directed to rewire the second defective wiring of the brain.

2. The system of claim 1, wherein the activities in the virtual environment are digital games.

3. The system of claim 1, wherein the activity module is further configured to provide the automated instructions to engage in the activity directed to rewire the first defective wiring to be performed in the real world environment, after the user has at least participated in the first activity.

4. The system of claim 1, wherein the activity module is further configured to provide the automated instructions to engage in the activity directed to rewire the second defective wiring to be performed in the real world environment, after the user has at least participated in the second activity.

5. The system of claim 1, wherein the activity module is further configured to enable the user to engage in the second activity, after the user has at least participated in the first activity.

6. A method for enabling a user to overcome sensitivity, the method comprising:
enabling the user to engage in at least a first activity in a virtual environment, wherein the first activity is directed to rewire a first defective wiring of the brain, wherein the first defective wiring results in amplifying one stimulus over other stimuli;
enabling the user to engage in at least a second activity in the virtual environment, wherein the second activity is directed to rewire a second defective wiring of the brain, wherein the second defective wiring results in inability to consider and weigh all the stimuli which is required for them to give an appropriate response, wherein symptom of the first and the second defective wirings is sensitivity;
providing automated instructions to the user to engage in at least one activity, wherein the one activity is performed in a real world environment, wherein the activity is directed to rewire the first defective wiring of the brain; and
providing automated instructions to the user to engage in yet another activity, wherein the yet another activity is performed in the real world environment, wherein the yet another activity is directed to rewire the second defective wiring of the brain.

7. The method of claim 6, wherein the activities in the virtual environment are digital games.

8. The method of claim 6, wherein the automated instructions to engage in the activity directed to rewire the first defective wiring, to be performed in the real world environment, is provided after the user has at least participated in the first activity.

9. The method of claim 6, wherein the automated instructions to engage in the activity directed to rewire the second defective wirings, to be performed in the real world environment, is provided after the user has at least participated in the second activity.

10. The method of claim 6, wherein the user is enabled to engage in the second activity, after the user has at least participated in the first activity.

11. A system for enabling a user to overcome sensitivity, the system comprising an activity module configured to:
enable the user to engage in at least a first activity in a virtual environment, wherein the first activity is directed to rewire a first defective wiring of the brain, wherein the first defective wiring results in amplifying one stimulus over other stimuli; and
enable the user to engage in at least a second activity in the virtual environment, wherein the second activity is directed to rewire a second defective wiring of the brain, wherein the second defective wiring results in inability to consider and weigh all the stimuli which is required for them to give an appropriate response, wherein symptom of the first and the second defective wirings is sensitivity, wherein engagement in the second activity is enabled after the user has at least participated in the first activity.

12. The system of claim 11, wherein, the first activity is directed to rewire the first defective wiring to increase the ability to disable/suppress the amplification of one stimulus over other stimuli; and
the second activity is directed to rewire the second defective wiring to increase the ability to consider and weigh all the stimuli which is required for them to give appropriate response.
